(19) United States
(12) Patent Application Publication
(10) Pub. No.: US 2015/0078414 A1
(43) Pub. Date: Mar. 19, 2015

(54) METHOD OF TESTING SEMICONDUCTOR DEVICE AND APPARATUS OF TESTING SEMICONDUCTOR DEVICE

(71) Applicant: Kabushiki Kaisha Toshiba, Tokyo (JP)

(72) Inventors: Yuuji Hisazato, Tokyo (JP); Kazuya Kodani, Kanagawa-ken (JP); Yo Sasaki, Saitama-ken (JP); Daisuke Hiratsuka, Kanagawa-ken (JP); Hitoshi Matsumura, Kanagawa-ken (JP); Hideaki Kitazawa, Kanagawa-ken (JP); Kenji Adachi, Tokyo (JP)

(73) Assignee: KABUSHIKI KAISHA TOSHIBA, Tokyo (JP)

(21) Appl. No.: 14/195,171

(22) Filed: Mar. 3, 2014

(30) Foreign Application Priority Data
Sep. 13, 2013 (JP) 2013-191108

(51) Int. Cl. G01N 25/72

(52) U.S. Cl. CPC G01N 25/72
USPC 374/5

(57) ABSTRACT

According to one embodiment, in a method of testing a semiconductor device, the semiconductor device has a semiconductor element and a substrate which are bonded by bonding material including metal fine particles. Image data of a heat distribution in the semiconductor device are temporally acquired while heating the semiconductor device. A time change of a fractal dimension based on the image data is calculated. An inclination of the time change of the fractal dimension is calculated. The inclination and a reference inclination set in advance are compared. Whether or not the semiconductor device is good is determined.

### CROSS REFERENCE TO RELATED APPLICATION

This application is based upon and claims the benefit of priority from the prior Japanese Patent Application 2013-191108, filed on Sep. 13, 2013, the entire contents of which are incorporated herein by reference.

### FIELD

Embodiments described herein are generally related to a method of testing a semiconductor device and an apparatus of testing a semiconductor device.

### BACKGROUND

A bonding material is used for a bonding portion between a semiconductor element and a substrate. A material such as Sn-95Pb to Sn-90Pb or SnAg is used for the bonding material. Further, in recent years, diffusion bonding or sinter bonding using metal fine particles such as Ag, Au or Cu is used.

Whether or not bonding portions are good is determined by observing the bonding portions of semiconductor elements one by one using a magnifying glass. Further, a bonding thickness of sinter bonding and diffusion bonding is several tens of micrometers (μm), and is about one tenth compared to that of a solder bonding portion. Therefore, performing an accurate test by way of visual checking is very difficult. Further, the thickness of the bonding portion is thin, and so thermal resistance is also little.

That is, a test which uses thermal resistance causes little resistance change, and is likely to cause an error. It is important to accurately determine whether or not a bonding portion of a semiconductor element which uses a bonding material including metal fine particles is good.

### BRIEF DESCRIPTION OF THE DRAWINGS

FIG. 1 is a flowchart illustrating a method of testing a semiconductor device according to a first embodiment.

FIG. 2 is a schematic cross-sectional view illustrating the semiconductor device according to the first embodiment.

FIGS. 3A1 to 3A8, FIGS. 3B1 to 3B8 and FIGS. 3C1 to 3C8 are views illustrating examples of image data of heat distributions according to the first embodiment.

FIG. 4 is a view illustrating time changes of fractal dimensions according to the first embodiment.

FIGS. 5 and 6 are views illustrating inclinations of time changes of fractal dimensions according to the first embodiment.

FIG. 7 is a view illustrating a relationship between a crack growth rate and an inclination of a time change of a fractal dimension according to the first embodiment.

FIGS. 8A to 8D are schematic cross-sectional views illustrating states of cracks according to the first embodiment.

FIG. 9 is a view illustrating an apparatus of testing a semiconductor device according to a second embodiment.

### DETAILED DESCRIPTION

According to one embodiment, in a method of testing a semiconductor device, the semiconductor device has a semiconductor element and a substrate which are bonded by bonding material including metal fine particles. Image data of a heat distribution in the semiconductor device are temporally acquired while heating the semiconductor device. A time change of a fractal dimension based on the image data is calculated. An inclination of the time change of the fractal dimension is calculated. The inclination and a reference inclination set in advance are compared. Whether or not the semiconductor device is good is determined.

Embodiments will be described below with reference to the drawings. In the drawings, the same reference numerals show the same or similar portions. The same portions in the drawings are denoted by the same numerals and a detailed explanation of the same portions is appropriately omitted, and different portions will be described.

### First Embodiment

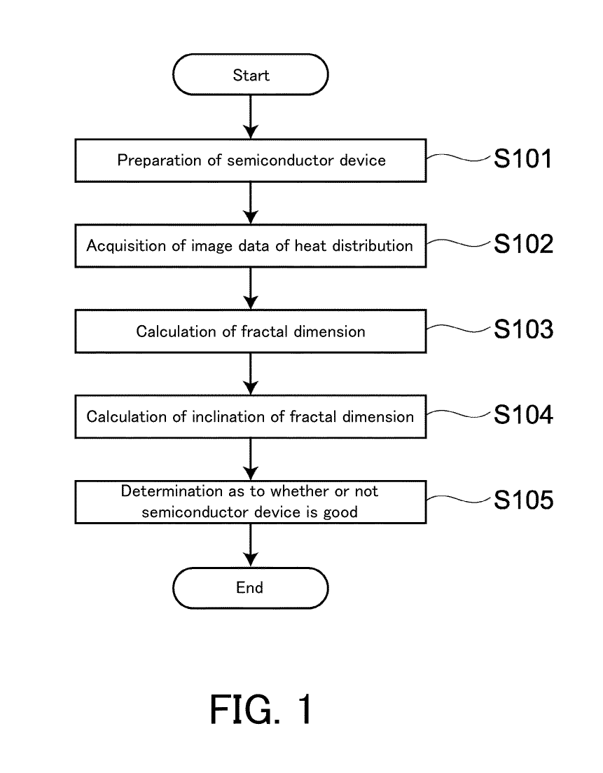

FIG. 1 is a flowchart illustrating a method of testing a semiconductor device in accordance with the first embodiment.

As illustrated in FIG. 1, the method of testing the semiconductor device of the embodiment includes preparation of a semiconductor device (step S101), acquisition of image data of a heat distribution (step S102), calculation of a fractal dimension (step S103), calculation of an inclination of the fractal dimension (step S104) and determination as to whether or not the semiconductor device is good (step S105).

Upon the preparation of the semiconductor device in step S101, a semiconductor device having a semiconductor element and a substrate bonded by a bonding material including metal fine particles is prepared. The semiconductor device is a target object whose bonding portion is determined to be good or not.

Upon the acquisition of the image data of the heat distribution in step S102, the semiconductor device prepared in step S101 is heated, and the image data of the heat distribution of the semiconductor device is temporally acquired. The image data of the heat distribution is an infrared image obtained by capturing the semiconductor element from above, for example. In step S102, while the semiconductor device is heated, the image data obtained by capturing the semiconductor element from above every time a predetermined time passes is acquired. In step S102, two or more items of image data of heat distributions are acquired as a heating time passes.

Upon the calculation of the fractal dimension in step S103, a time change of the fractal dimension is calculated based on the image data of the heat distribution taken in step S102.

The fractal dimension is calculated in accordance with following equation

N(R)·RD=C (1)

In equation (1), N(R) denotes the number of cubes which are required for covering, R denotes a length of one side of a cube, D denotes the fractal dimension and C denotes a constant (a volume of a target cube).

The fractal dimension is an indicator which represents complexity of a distribution shape. A temperature distribution can be represented by a two or three fractal dimension.

Upon the calculation of the inclination of the fractal dimension in step S104, an inclination of a time change of the fractal dimension is calculated. In step S103, the time change of the fractal dimension is calculated. In step S104, the inclination of the time change of the fractal dimension is calculated by linear approximation, for example.

Upon determination as to whether or not the semiconductor device is good in step S105, the inclination of the time change of the fractal dimension calculated in step S104 and a reference inclination set in advance are compared, and whether or not the semiconductor device is good is determined. That is, there is a correlation between the inclination of the time change of the fractal dimension and a bonding state of the bonding portion (a crack growth rate, for example). The correlation is used to determine whether or not the bonding state of the bonding portion is good depending on whether or not a value of the inclination of the time change of the fractal dimension exceeds a value of the reference inclination.

In the embodiment, it is possible to precisely determine using a fractal dimension whether or not the bonding portion is good, the bonding portion being hardly determined to be good or not only by referring to an image of a heat distribution corresponding to a heating time of a semiconductor device. Particularly when a bonding material includes metal fine particles including at least one of Ag, Au and Cu selected from a group including Ag, Au and Cu, it is difficult to precisely determine whether or not a bonding portion is good, from an image of a heat distribution. As in the embodiment, whether or not a bonding portion is good is precisely determined without destruction based on the inclination of the time change of the fractal dimension.

The semiconductor element includes one of SiC and GaN, for example. The semiconductor element including SiC or GaN can operate at a higher temperature than that of a semiconductor element including Si. The semiconductor element including SiC or GaN, for example, can operate at 200° C. or more. When the semiconductor element and the substrate are bonded through the bonding material, the bonding material needs to be sufficiently robust against process or an operation at a high temperature. In the embodiment, whether or not the semiconductor device is good is precisely determined based on characteristics of the inclination of the time change of the fractal dimension in the semiconductor device whose semiconductor element including SiC or GaN and the substrate are bonded.

Upon the calculation of the inclination of the time change of the fractal dimension in step S104, an inclination within 100 seconds from start of heating of the semiconductor device may be calculated. A size of the semiconductor element including SiC or GaN, for example, is smaller than a size of the semiconductor element including Si. The characteristics of the inclination of the time change of the fractal dimension appear in the semiconductor element including SiC or GaN at a comparatively early stage from start of heating. Consequently, precision to determine whether or not the semiconductor device is good is improved by calculating the inclination within 100 seconds from start of heating. The precision to determine whether or not the semiconductor device is good is improved particularly by calculating an inclination within 70 seconds from start of heating.

Next, a specific example will be described.

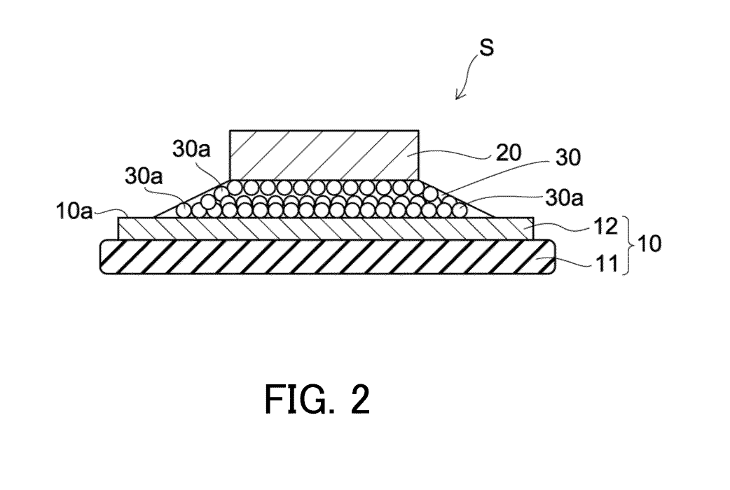

FIG. 2 is a schematic cross-sectional view illustrating the semiconductor device.

As illustrated in FIG. 2, a semiconductor device S includes a substrate 10, a semiconductor element 20 which is mounted on a first surface 10a of the substrate 10, and a bonding material 30 which is provided between the substrate 10 and the semiconductor element 20. The substrate 10 includes a support member 11 made of ceramics, for example, and a conductive member 12 formed on the surface of the support member 11. A Cu film, for example, is used for the conductive member 12.

The semiconductor element 20 is cut as a chip from a wafer. The semiconductor element 20 includes one of SiC and GaN. In the specific example, the semiconductor element 20 includes SiC. The semiconductor element 20 is a power transistor (IGBT as Insulated Gate Bipolar Transistor, for example) or a power diode (FRD as Fast Recovery Diode, for example).

The bonding material 30 includes metal fine particles 30a. The metal fine particles 30a include at least one selected from the group including Ag, Au and Cu. In the specific example, Ag is used for the metal fine particles 30a. The diameter of the metal fine particles 30a is several tens of nanometers (nm) or more and several hundreds of nm or less, for example. When the bonding material 30 including Ag fine particles is used, a melting point of the bonding material 30 becomes equal to the melting point of Ag (960° C.). The semiconductor element 20 is sinter-bonded on the first surface 10a of the substrate 10 through the bonding material 30. In the description, metal includes not only pure metal but also an intermetallic compound (alloy).

In the specific example, while the semiconductor device S is heated, image data of a heat distribution is acquired.

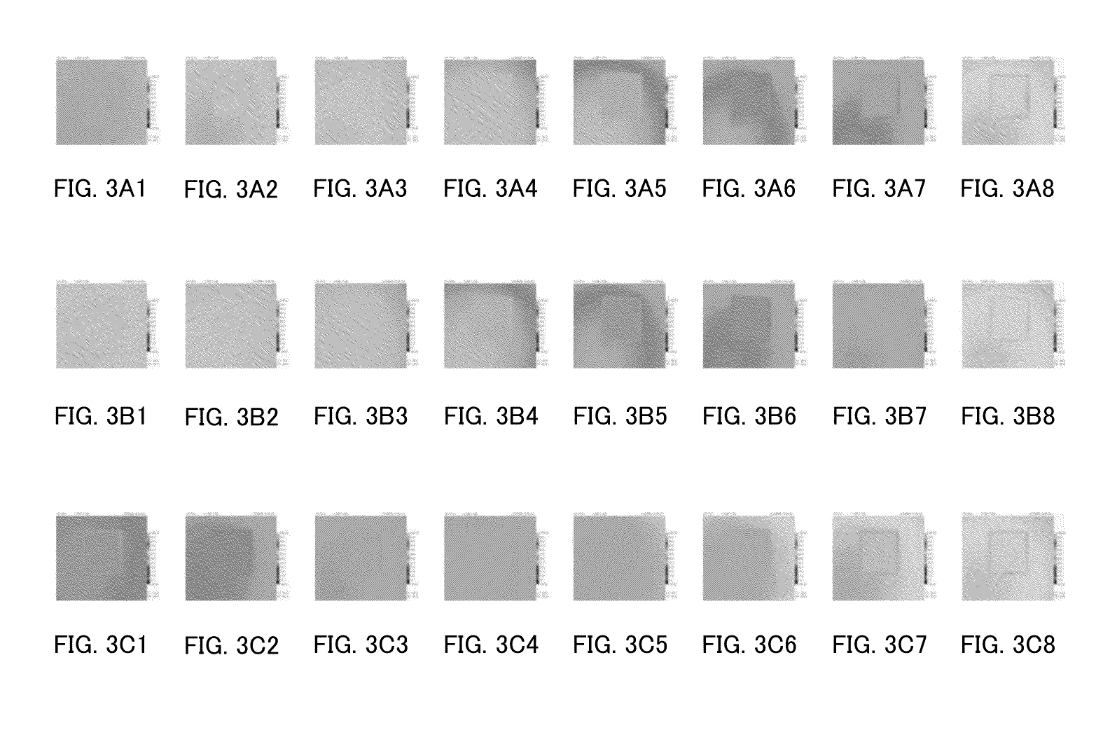

FIGS. 3A1 to 3A8, FIGS. 3B1 to 3B8 and FIGS. 3C1 to 3C8 are views illustrating examples of image data of heat distributions.

FIGS. 3A1 to 3A8 illustrate image data of heat distributions in a first semiconductor device S1. FIGS. 3A1 to 3A7 illustrate image data per ten seconds from start of heating to 70 seconds, and FIG. 3A8 illustrates image data after 240 seconds from start of heating.

FIGS. 3B1 to 3B8 illustrate image data of heat distributions in a second semiconductor device S2. FIGS. 3B1 to 3B7 illustrate image data per 10 seconds from start of heating to 70 seconds, and FIG. 3B8 illustrates image data after 240 seconds from start of heating.

FIGS. 3C1 to 3C8 illustrate image data of heat distributions in a third semiconductor device S3. FIGS. 3C1 to 3C7 illustrate image data per 10 seconds from start of heating to 70 seconds, and FIG. 3C8 illustrates image data after 240 seconds from start of heating.

Meanwhile, in order to simulate flaws, the first semiconductor device S1 and the third semiconductor device S3 are subjected to thermal cycles hundred times, and the second semiconductor device S2 is subjected to thermal cycles 500 times. In one thermal cycle, 200° C. and −50° C. are maintained for 30 minutes.

In the following description, the first semiconductor device S1, the second semiconductor device S2 and the third semiconductor device S3 are collectively referred to as the semiconductor device S.

The semiconductor device S is heated by a heat source such as a high frequency oscillator or a lamp. Image data of a heat distribution is acquired using temperature measuring equipment such as a thermography. The temperature measuring equipment takes in data of a temperature distribution on a surface of the semiconductor element captured from above of the semiconductor device S. The image data of the heat distribution is displayed on a monitor, for example, as an image by color-coding data of a temperature distribution per predetermined temperature range.

FIGS. 3A1 to 3A8, FIGS. 3B1 to 3B8 and FIGS. 3C1 to 3C8 illustrate examples of image data of heat distributions taken in as described above. It is difficult to determine whether or not the bonding portion between the semiconductor element 20 and the substrate 10 is good only by referring to the image data.

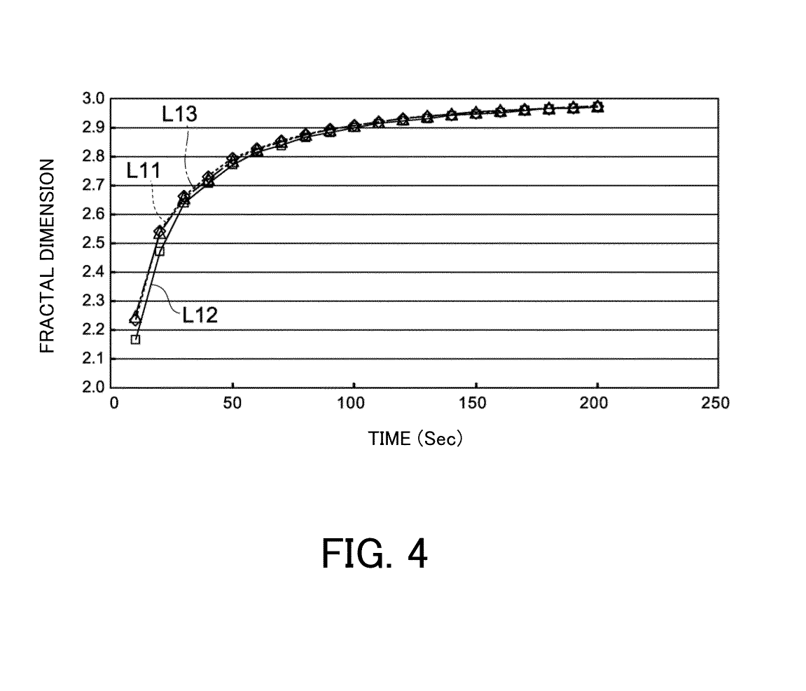

FIG. 4 is a view illustrating time changes of fractal dimensions.

A horizontal axis in FIG. 4 indicates a time (heating time), and a vertical axis indicates a fractal dimension. The fractal dimension is calculated using above equation (1) based on the image data of the heat distributions illustrated in FIGS. 3A1 to 3A8, FIGS. 3B1 to 3B8 and FIGS. 3C1 to 3C8.

In FIG. 4, a line L11 indicates a time change of a fractal dimension calculated based on the image data of the first semiconductor device S1 illustrated in FIGS. 3A1 to 3A8. A line L12 indicates a time change of a fractal dimension calculated based on the image data of the second semiconductor device S2 illustrated in FIGS. 3B1 to 3B8. A line L13 indicates a time change of a fractal dimension calculated based on the image data of the third semiconductor device S3 illustrated in FIGS. 3C1 to 3C8.

The fractal dimension changes between 2 and 3 until 240 seconds from start of heating on each of the lines L11, L12 and L13. The fractal dimension immediately after start of heating is a value close to 2, and, when the heating time increases, the fractal dimension becomes close to 3. The time change of the fractal dimension within 100 seconds from immediately after heating is greater than the time change of the fractal dimension after 100 seconds to 240 seconds.

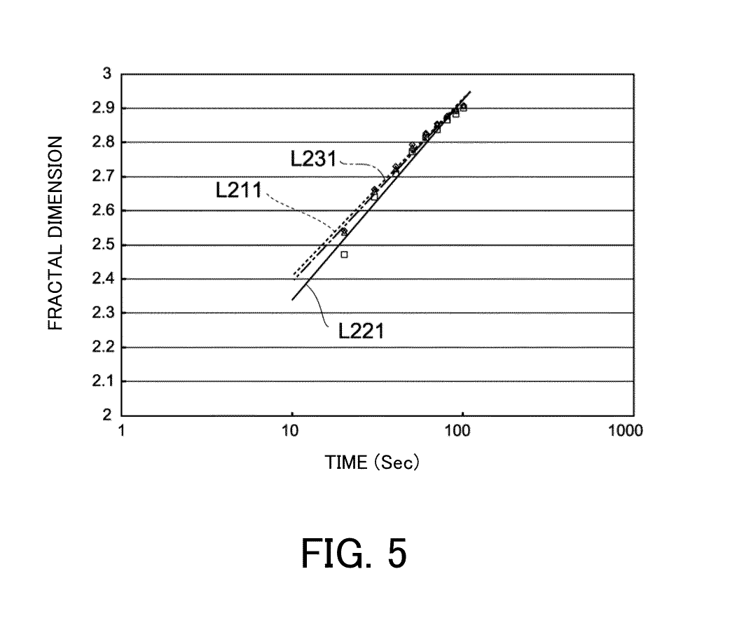

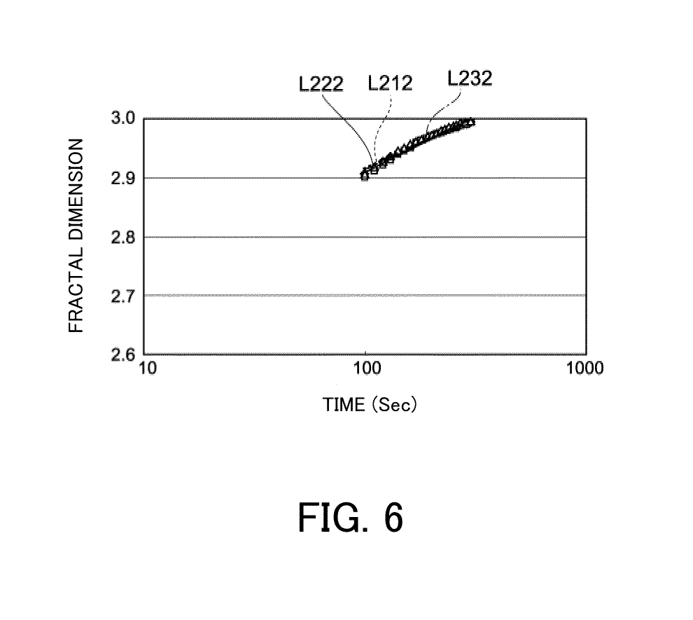

FIGS. 5 and 6 are views illustrating inclinations of time changes of fractal dimensions.

Each of the horizontal axes in FIGS. 5 and 6 indicates time (heating time) as logarithm, and each of the vertical axes indicates fractal dimension.

FIG. 5 illustrates the time changes of the fractal dimensions and the inclinations of the time changes from start of heating to 100 seconds. In FIG. 5, a line L211 indicates the inclination of the time change of the fractal dimension of the first semiconductor device S1. A line L221 indicates the inclination of the time change of the fractal dimension of the second semiconductor device S2. A line L231 indicates the inclination of the time change of the fractal dimension of the third semiconductor device S3.

FIG. 6 illustrates time changes of the fractal dimensions and the inclinations of the time changes from 100 seconds to 240 seconds upon heating. In FIG. 6, a line L212 indicates the inclination of the time change of the fractal dimension of the first semiconductor device S1. A line L222 indicates the inclination of the time change of the fractal dimension of the second semiconductor device S2. A line L232 indicates the inclination of the time change of the fractal dimension of the third semiconductor device S3.

The lines L211, L221, L231, L212, L222 and L232 linearly approximate the time changes of the fractal dimensions. When the horizontal axes in FIGS. 5 and 6 are x and the vertical axes are y, an equation of linear approximation of a time change of a fractal dimension is expressed as y=a X log(x)+b. Meanwhile, a indicates an inclination.

An equation of linear approximation of each of the lines L211, L221, L231, L212, L222 and L232 is as follows.

Line L211 . . . y=0.2262×log(x)+1.8871

Line L221 . . . y=0.2561×log(x)+1.7467

Line L231 . . . y=0.2298×log(x)+1.869

Line L212 . . . y=0.07×log(x)+2.57

Line L222 . . . y=0.08×log(x)+2.53

Line L232 . . . y=0.08×log(x)+2.56

As is clear from FIG. 5 and values of the inclinations of the lines L211, L221 and L231, the inclinations of time changes of fractal dimensions within 100 seconds from start of heating significantly differ between the first semiconductor device S1 and the third semiconductor device S3, and the second semiconductor device S2. The inclination of the first semiconductor device S1 is substantially the same as the inclination of the third semiconductor device S3.

Meanwhile, as is clear from FIG. 6 and values of the inclinations of the lines L212, L222 and L232, the inclinations of the time changes of the fractal dimensions from 100 seconds to 240 seconds upon heating do not substantially differ between the first semiconductor device S1, the second semiconductor device S2 and the third semiconductor device S3.

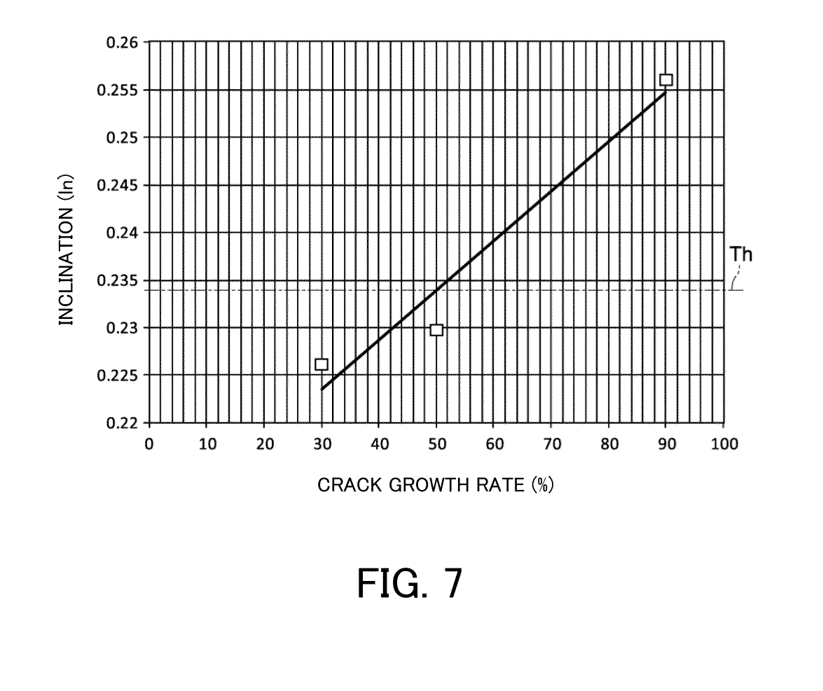

FIG. 7 is a view illustrating a relationship between a crack growth rate and an inclination of a time change of a fractal dimension.

A horizontal axis in FIG. 7 indicates a crack growth rate (%), and a vertical axis indicates the inclination of the time change of the fractal dimension. FIG. 7 illustrates a relationship between the inclination of the time change of the fractal dimension within 100 seconds from start of heating of the semiconductor device, and the crack growth rate. The crack growth rate is a rate of a length of a crack with respect to a bonding length of the bonding material 30 which bonds the semiconductor element 20 and the substrate 10.

As illustrated in FIG. 7, when the crack growth rate is low, the inclination of the time change of the fractal dimension tends to become small. Meanwhile, when the crack growth rate is high, the inclination of the time change of the fractal dimension tends to become great.

In the specific example, whether or not the bonding portion (bonding material 30) between the semiconductor element 20 and the substrate 10 is good, that is, whether or not the semiconductor device is good is determined using the correlation between the crack growth rate and the inclination of the time change of the fractal dimension.

An inclination corresponding to a crack growth rate 50% is used as a reference inclination Th, for example, and the calculated inclination of the time change of the fractal dimension and the reference inclination Th are compared. The semiconductor device is determined to be “good” when the calculated inclination of the time change of the fractal dimension is not more than the reference inclination Th. Meanwhile, the semiconductor device is determined to be “poor” when the calculated inclination of the time change of the fractal dimension is greater than the reference inclination Th. In addition, the reference inclination Th is an example, and may be another inclination.

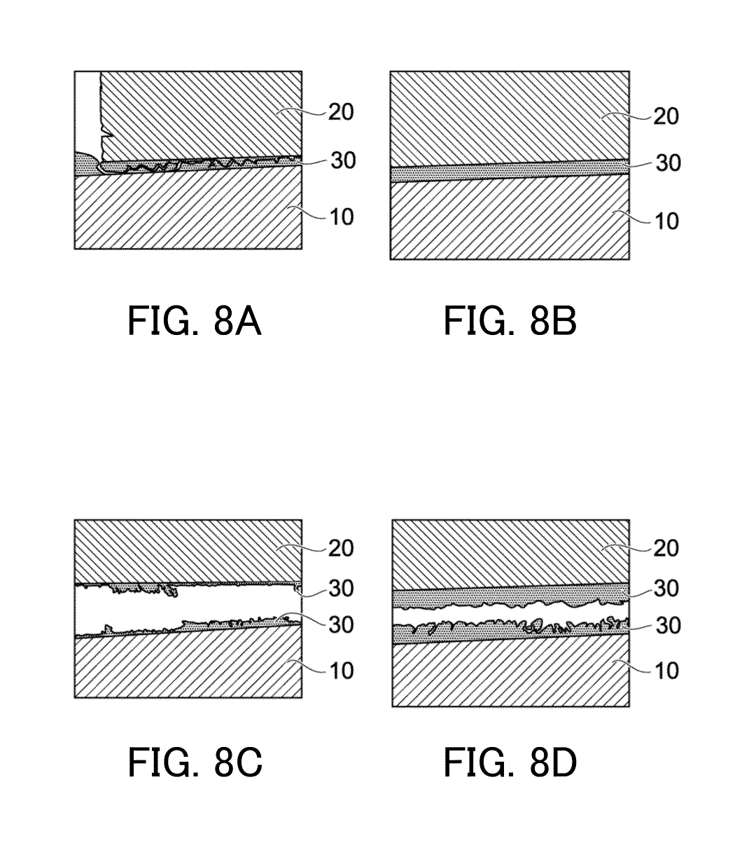

FIGS. 8A to 8D are schematic cross-sectional views illustrating states of cracks.

FIG. 8A illustrates a state of a bonding portion on one end side of the semiconductor element of the first semiconductor device S1, and FIG. 8B illustrates a state of the bonding portion on the other end side of the semiconductor element of the first semiconductor device S1. FIG. 8C illustrates a state of a bonding portion on one end side of the semiconductor element of the second semiconductor device S2, and FIG. 8D illustrates a state of the bonding portion on the other end side of the semiconductor element of the second semiconductor device S2. Meanwhile, a crack is likely to be produced in the bonding material 30 provided between the semiconductor element 20 and the substrate 10.

As illustrated in FIGS. 8A and 8B, while a crack is produced at a portion of one end side of the semiconductor element in the first semiconductor device S1, the crack is not produced on the other end side of the semiconductor element. Further, as illustrated in FIGS. 8C and D, cracks are produced on both of one end side and the other end side of the semiconductor element in the second semiconductor device S2.

It is difficult to determine whether or not the semiconductor device is good from the image data of the heat distributions illustrated in FIGS. 3A1 to 3A8, FIGS. 3B1 to 3B8 and FIGS. 3C1 to 3C8. However, in the specific example, it is possible to precisely determine whether or not the semiconductor device is good based on the calculated inclination of the time change of the fractal dimension of the semiconductor device using the correlation between the crack growth rate and the inclination of the time change of the fractal dimension.

Further, in the specific example, the crack growth rate may be predicted from the calculated inclination of the time change of the fractal dimension using the correlation between the crack growth rate and the inclination of the time change of the fractal dimension illustrated in FIG. 7. When the calculated inclination of the time change of the fractal dimension of the semiconductor device is 0.225, for example, the crack growth rate is predicted to be about 30% from the relationship in FIG. 7. Further, when the calculated inclination is 0.2555, the crack growth rate is predicted to be about 90% from the relationship in FIG. 7.

Thus, in accordance with the specific example, it is possible to precisely determine whether or not the bonding portion between the semiconductor element 20 and the substrate 10 is good from the calculated inclination of the time change of the fractal dimension of the semiconductor device. Further, it is also possible to predict a crack growth rate from the calculated inclination of the time change of the fractal dimension.

Meanwhile, although a case has been described herein where the metal fine particles 30a are pure metal fine particles such as Ag, Au and Cu, the metal fine particles 30a may be intermetallic compound fine particles. The intermetallic compound is CuSn alloy (Cu₃Sn and Cu₆Sn₅) and AgSn alloy (Ag₃Sn), for example. The CuSn alloy has a lower melting point than that of Cu, and the AgSn alloy has a lower melting point than that of Ag. The melting point of Ag₃Sn is approximately 480° C., for example, and is lower than the melting point of Ag (960° C.).

When the metal fine particles 30a are intermetallic compound fine particles, there is an advantage of adequately adjusting the melting point of the bonding material 30 according to a purpose. As well as the metal fine particles 30a being pure metal fine particles, even when the metal fine particles 30a are intermetallic compound fine particles, it is possible to precisely determine whether or not the bonding portion between the semiconductor element 20 and the substrate 10 is good, from the inclination of the time change of the fractal dimension.

### Second Embodiment

Next, an apparatus of testing a semiconductor device in accordance with the second embodiment will be described.

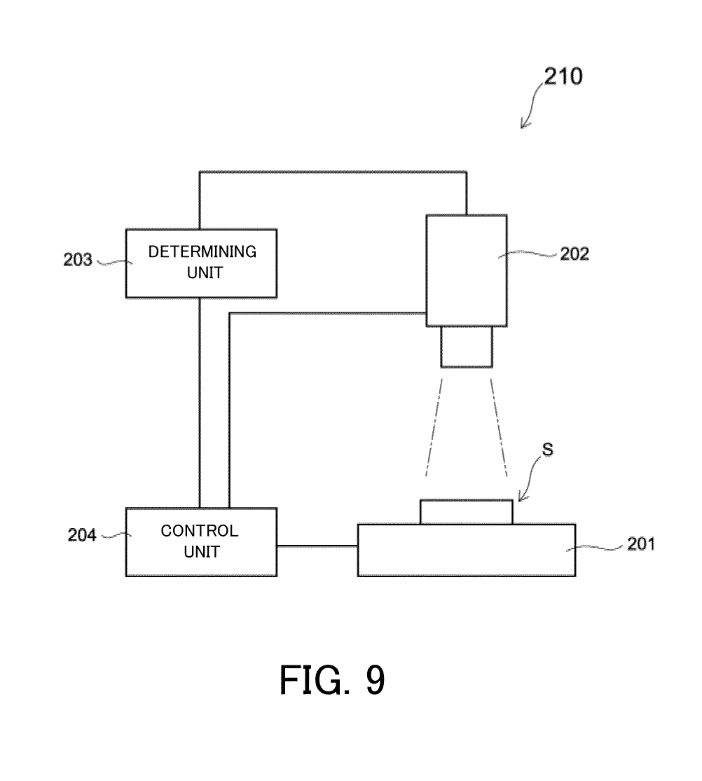

FIG. 9 is a view illustrating the apparatus of the semiconductor device of the second embodiment.

As illustrated in FIG. 9, the apparatus 210 of testing the semiconductor device of the embodiment has a heating unit 201, an image acquiring unit 202 and a determining unit 203. The apparatus 210 of testing the semiconductor device is a device which carries out the method of testing the semiconductor device of the first embodiment as described above.

The heating unit 201 has a heat source (a high frequency oscillator or a lamp, for example) which heats a semiconductor device S. The heat source is desirably configured to intensely heat the semiconductor device S. It is desirable that a size of a heated region is desirably substantially equal to a size of the semiconductor device S, for example. By intensely heating the semiconductor device S, a heat distribution of the semiconductor device S is hardly influenced by heating of other portions.

As illustrated in FIG. 2, the semiconductor device S has a substrate 10, a semiconductor element 20 and a bonding material 30. The semiconductor element 20 includes one of SiC and GaN, for example. The bonding material 30 includes metal fine particles 30a. The metal fine particles 30a include at least one selected from the group including Ag, Au and Cu.

The image acquiring unit 202 has an infrared camera which outputs an electric signal in accordance with the amount of a received infrared ray, for example. The image acquiring unit 202 temporally acquires image data of a heat distribution of the semiconductor device S while the heating unit 201 heats the semiconductor device S.

The determining unit 203 calculates a time change of fractal dimension based on the image data acquired by the image acquiring unit 202. Further, the determining unit 203 calculates the inclination of the time change of the fractal dimension. Furthermore, the determining unit 203 compares the calculated inclination and a reference inclination Th set in advance to determine whether or not the semiconductor device is good.

The determining unit 203 may calculate an inclination of a time change of a fractal dimension within 100 seconds from start of heating of the semiconductor device. Further, the determining unit 203 may predict a growth rate of a crack produced between the semiconductor element 20 and the substrate 10 from a value of the inclination of the time change of the fractal dimension.

The apparatus 210 of testing the semiconductor device further has a control unit 204. The control unit 204 controls the heating unit 201, the image acquiring unit 202 and the determining unit 203.

At least one of the control unit 204 and the determining unit 203 may be configured by a computer. At least one of the control unit 204 and the determining unit 203 may be connected with another configuration through a network.

At least one of the control unit 204 and the determining unit 203 may be realized by program processing (a semiconductor element bonding portion testing program) to be executed by the computer.

The semiconductor element bonding portion testing program may be recorded in a predetermined medium. Further, the semiconductor element bonding portion testing program may be distributed through the network.

The apparatus 210 of testing the semiconductor device of the embodiment can precisely determine whether or not the bonding portion between the semiconductor element 20 and the substrate 10 is good, from a calculated inclination of a time change of a fractal dimension of a semiconductor device. Further, it is also possible to predict a crack growth rate from the calculated inclination of the time change of the fractal dimension.

As described above, the method of testing the semiconductor device and the apparatus of testing the semiconductor device of the embodiments can accurately determine whether or not a semiconductor device is good.

In addition, although the embodiments have been described, the invention is by no means limited to the embodiments. Addition, removal or design change of components adequately made by one of ordinary skill in art on the above-described embodiments and adequate combinations of features of each embodiment are incorporated in the scope of the invention as long as the spirit of the invention is kept.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of testing a semiconductor device, comprising:
temporally acquiring image data of a heat distribution in a semiconductor device having a semiconductor element and a substrate bonded by a bonding material including metal fine particles while heating the semiconductor device;
calculating a time change of a fractal dimension based on the image data;
calculating an inclination of the time change of the fractal dimension; and
determining whether or not the semiconductor device is good based on comparing the inclination and a reference inclination set in advance.

2. The method of testing the semiconductor device according to claim 1, wherein the calculating the inclination of the time change of the fractal dimension comprises calculating the inclination within 100 seconds from start of the heating.

3. The method of testing the semiconductor device according to claim 1, further comprising predicting a growth rate of a crack produced between the semiconductor element and the substrate, from a value of the inclination of the time change of the fractal dimension.

4. The method of testing the semiconductor device according to claim 1, wherein the semiconductor element comprises one of SiC and GaN.

5. The method of testing the semiconductor device according to claim 1, wherein the metal fine particles include at least one selected from the group including Ag, Au and Cu.

6. The method of testing the semiconductor device according to claim 2, further comprising predicting a growth rate of a crack produced between the semiconductor element and the substrate, from a value of the inclination of the time change of the fractal dimension.

7. The method of testing the semiconductor device according to claim 2, wherein the semiconductor element comprises one of SiC and GaN.

8. The method of testing the semiconductor device according to claim 2, wherein the metal fine particles include at least one selected from the group including Ag, Au and Cu.

9. The method of testing the semiconductor device according to claim 3, wherein the semiconductor element comprises one of SiC and GaN.

10. The method of testing the semiconductor device according to claim 3, wherein the metal fine particles include at least one selected from the group including Ag, Au and Cu.

11. An apparatus of testing a semiconductor device, comprising:
a heating unit configured to heat a semiconductor device having a semiconductor element and a substrate bonded by a bonding material including metal fine particles;
an image acquiring unit configured to temporally acquire image data of a heat distribution in the semiconductor device while the heating unit heats the semiconductor device; and
a determining unit configured to calculate a time change of a fractal dimension and an inclination of the time change based on the image data acquired by the image acquiring unit, compare the inclination and a reference inclination set in advance, and determine whether or not the semiconductor device is good.

12. The apparatus of testing a semiconductor device according to claim 11, wherein the determining unit calculates the inclination within 100 seconds from start of the heating of the semiconductor device.

13. The apparatus of testing the semiconductor device according to claim 11, wherein the determining unit predicts a growth rate of a crack produced between the semiconductor element and the substrate, from a value of the inclination of the time change of the fractal dimension.

14. The apparatus of testing the semiconductor device according to claim 11, wherein the semiconductor element comprises one of SiC and GaN.

15. The apparatus of testing the semiconductor device according to claim 11, wherein the metal fine particles include at least one selected from the group including Ag, Au and Cu.

16. The apparatus of testing the semiconductor device according to claim 12, wherein the determining unit predicts a growth rate of a crack produced between the semiconductor element and the substrate, from a value of the inclination of the time change of the fractal dimension.

17. The apparatus of testing the semiconductor device according to claim 12, wherein the semiconductor element comprises one of SiC and GaN.

18. The apparatus of testing the semiconductor device according to claim 12, wherein the metal fine particles include at least one selected from the group including Ag, Au and Cu.

19. The apparatus of testing the semiconductor device according to claim 16, wherein the semiconductor element comprises one of SiC and GaN.

20. The apparatus of testing the semiconductor device according to claim 16, wherein the metal fine particles include at least one selected from the group including Ag, Au and Cu.
